(19) United States
(12) Patent Application Publication
(10) Pub. No.: US 2025/0292416 A1
(43) Pub. Date: Sep. 18, 2025

(54) VIDEO PROCESSING SYSTEM, VIDEO PROCESSING METHOD, AND VIDEO PROCESSING APPARATUS

(71) Applicant: NEC Corporation, Minato-ku, Tokyo (JP)

(72) Inventors: Florian BEYE, Tokyo (JP); Takanori IWAI, Tokyo (JP); Koichi NIHEI, Tokyo (JP); Hayato ITSUMI, Tokyo (JP); Katsuhiko TAKAHASHI, Tokyo (JP); Ryuhei ANDO, Tokyo (JP); Yasunori BABAZAKI, Tokyo (JP); Jun PIAO, Tokyo (JP)

(73) Assignee: NEC Corporation, Minato-ku, Tokyo (JP)

(21) Appl. No.: 18/861,248

(22) PCT Filed: Aug. 26, 2022
(86) PCT No.: PCT/JP2022/032204

§ 371 Date: Oct. 29, 2024

(51) Int. Cl. G06T 7/246

(52) U.S. Cl. CPC G06T 7/246; G06T 2207/10016; G06T 2207/20081; G06T 2207/30241

(57) ABSTRACT

Provided is a video processing system including: a detection means for detecting a tracking target from an input video; a trajectory prediction means for predicting a trajectory of the tracking target in the video; and a tracking means for tracking the tracking target, and when there is a missing region in the video, for estimating a position of the tracking target in the missing region using a prediction result of the trajectory prediction means. The video processing system may further include a determination means for determining whether or not the tracking target tracked by the tracking means is the same as the tracking target detected by the detection means; and a trajectory information output means for assigning identification information to the detected tracking target.

### TECHNICAL FIELD

The present disclosure relates to a video processing system, a video processing method, and a video processing apparatus.

### BACKGROUND ART

As a related technique, Patent Literature 1 discloses an object tracking apparatus capable of reliably tracking an object moving at a high speed and drawing an accurate trajectory without attaching a sensor to the object. The object tracking apparatus includes an infrared light detection unit that detects a detection blob from an infrared image, a trajectory generation unit that generates a trajectory based on the detected detection blob, and a position prediction unit that calculates a predicted position and a search range of the detection blob. In addition, the object tracking apparatus includes a history data generation unit that generates history data for each trajectory T, a delay time determination unit that compares and determines an elapsed time and a delay time of the history data, and a detection success count determination unit that determines whether or not the number of detection success counts is equal to or greater than a threshold. The object tracking apparatus further includes a visible image delay unit that delays the visible image by a delay time m, and a trajectory drawing unit that draws the trajectory T in the visible image.

### CITATION LIST

### Patent Literature

Patent Literature 1: Japanese Unexamined Patent Application Publication No. 2018-78431

### SUMMARY OF INVENTION

### Technical Problem

In the related techniques, objects are tracked by a tracking apparatus as described above. However, when video is received via a network, the video may be disturbed due to packet loss due to deterioration of a communication environment of the network. For example, a frame is missing or a portion of frame is missing. In such a degraded video, an object may not be accurately tracked. Therefore, an object of the present disclosure is to propose a suitable object tracking method at the time of video distribution via a network.

### Solution to Problem

A video processing system of the present disclosure includes:
a detection means for detecting a tracking target from an input video;
a trajectory prediction means for predicting a trajectory of the tracking target in the video; and
a tracking means for tracking the tracking target, when there is a missing region in the video, in the missing region using a prediction result of the trajectory prediction means.

A video processing method of the present disclosure includes:
detecting a tracking target from an input video;
predicting a trajectory of the tracking target in the video; and
when there is a missing region in the video, tracking the tracking target in the missing region using a result of prediction of the trajectory.

A video processing apparatus of the present disclosure includes:
a detection means for detecting a tracking target from an input video;
a trajectory prediction means for predicting a trajectory of the tracking target in the video; and
a tracking means for tracking the tracking target, when there is a missing region in the video, in the missing region using a prediction result of the trajectory prediction means.

### Advantageous Effects of Invention

According to the present disclosure, it is possible to provide a suitable object tracking method at the time of video distribution via a network.

### BRIEF DESCRIPTION OF DRAWINGS

FIG. 1 is a block diagram of a video processing system according to an example embodiment.

FIG. 2 is a block diagram of the video processing apparatus according to the example embodiment.

FIG. 3 is a flowchart of a video processing method according to the example embodiment.

FIG. 4 is a schematic diagram of a remote monitoring system according to the example embodiment.

FIG. 5 is a block diagram of the video processing system according to a first example embodiment.

FIG. 6 is a flowchart of a video processing method according to the first example embodiment.

FIG. 7 is a flowchart of a video processing method according to the first example embodiment.

FIG. 8 is a diagram illustrating an example of a storage format of trajectory reliability according to the first example embodiment.

FIG. 9 is a diagram illustrating a detection example in which the trajectory reliability decreases according to the first example embodiment.

FIG. 10 is a diagram illustrating a detection example in which the trajectory reliability is constant and does not fall below a predetermined value according to the first example embodiment.

FIG. 11 is a diagram illustrating an example in which an object cannot be tracked due to a missing frame.

### EXAMPLE EMBODIMENT

### Example Embodiment

Example embodiments of the present disclosure will be described below with reference to the drawings. However, the invention according to the claims is not limited to the following example embodiment. Not all the configurations described in the example embodiment are essential as means for solving the problem. To clarify description, in the following description and drawings, omission and simplification are made as appropriate. In the drawings, the same elements are denoted by the same reference numerals, and repeated description is omitted as necessary.

### (Description of Video Processing System According to Example Embodiment)

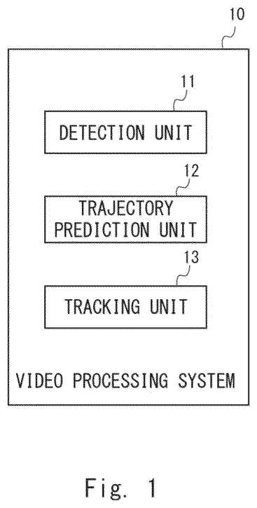

FIG. 1 is a block diagram of a video processing system according to an example embodiment. A video processing system 10 according to the example embodiment will be described with reference to FIG. 1. The video processing system 10 can be applied to, for example, a remote monitoring system that collects videos via a network and monitors the videos.

As illustrated in FIG. 1, the video processing system 10 according to the example embodiment includes a detection unit 11, a trajectory prediction unit 12, and a tracking unit 13.

The detection unit 11 detects a tracking target from the input video. The tracking target is an object set as a target to be tracked, and is, for example, a moving object such as an automobile, a bicycle, a robot, or a ship, a person, or the like. The detection unit 11 transmits, to the trajectory prediction unit 12, extraction information that is information about the tracking target and is extracted by a detection process. For example, the detection unit 11 preferably transmits, as the extraction information, position information of the tracking target obtained by surrounding the detection target with a rectangular frame, but is not limited thereto. The frame surrounding the detection target may be any of a rectangle, a circle, and an indefinite shape. Furthermore, the information to be detected may be not only the position information but also position information in the time series of the tracking target, a speed of the tracking target, a motion vector of the tracking target, identification information of the tracking target, and a type of the tracking target.

The trajectory prediction unit 12 predicts a trajectory of the tracking target in the video. The trajectory can also be read as a figure drawn while the position satisfies a certain condition. Based on the extraction information, the trajectory prediction unit 12 predicts the position of the tracking target in the video after the video on which the detection process has been performed.

The tracking unit 13 tracks the tracking target. When there is a missing region in the video, the tracking unit 13 estimates the position of the tracking target in the missing region using a prediction result of the trajectory prediction unit.

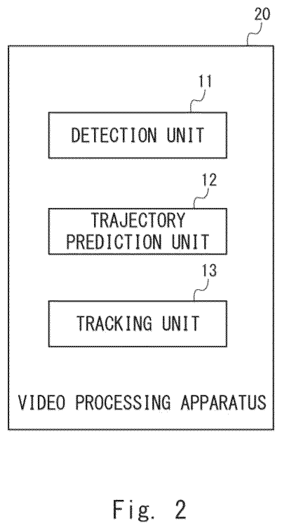

Note that the video processing system 10 may include one apparatus or a plurality of apparatuses. FIG. 2 illustrates a configuration of video processing apparatus 20 according to the example embodiment. As illustrated in FIG. 2, the video processing apparatus 20 may include the detection unit 11, the trajectory prediction unit 12, and the tracking unit 13 illustrated in FIG. 1, or an apparatus including the detection unit 11 and an apparatus including the trajectory prediction unit 12 and the tracking unit 13 may communicate with each other and operate as a function of the video processing system. In addition, part or all of the video processing system 10 may be deployed in a cloud. For example, the functions may be distributed in the cloud.

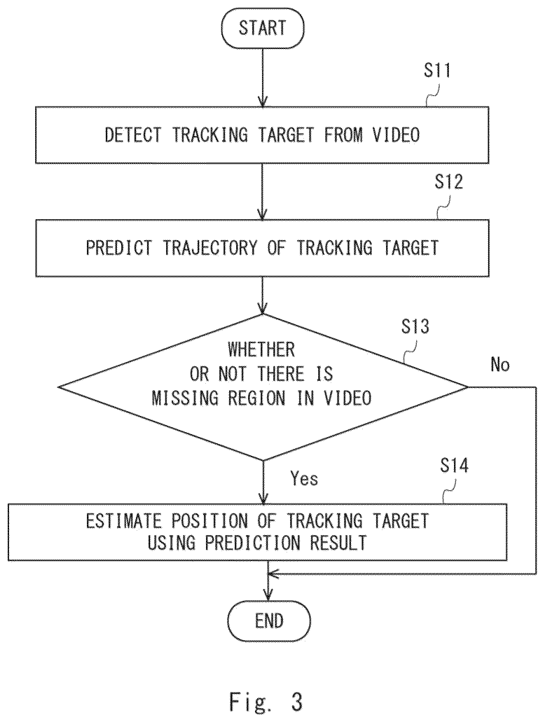

FIG. 3 is a flowchart of a video processing method according to the example embodiment. For example, the video processing method according to the example embodiment is executed by video processing system 10 in FIG. 1 and the video processing apparatus in FIG. 2. As illustrated in FIG. 3, first, the tracking target is detected from the video (step S11). Next, a trajectory of the tracking target is predicted (step S12). Next, it is determined whether or not there is a missing region in the video (step S13). If there is no missing region (No in step S13), tracking of the tracking target is performed until the tracking target moves out of an imaging range, and the process is ended. If there is a missing region (Yes in step S13), the position of the tracking target is estimated using the prediction result, and the process is ended.

As described above, in the video processing system according to the example embodiment, when there is a missing region in the video, the position of the tracking target in the missing region is estimated using the prediction result of a tracking prediction unit. As a result, it is possible to provide a suitable object tracking method at the time of video distribution via a network.

### (Description of Remote Monitoring System According to Example Embodiment)

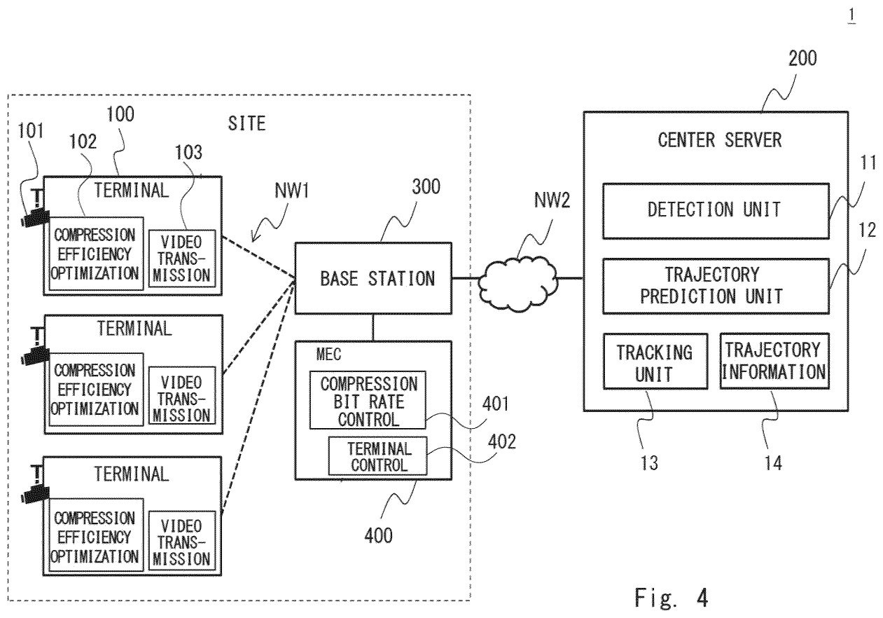

A remote monitoring system which is an example of a system to which the example embodiment is applied will be described. FIG. 4 is a schematic diagram of the remote monitoring system according to the example embodiment. The remote monitoring system according to the example embodiment will be described with reference to FIG. 4.

A remote monitoring system 1 is a system that monitors a captured area by a video captured by a camera. Note that, since the video includes a plurality of time-series images (also referred to as frames), the video and the image may be used as interchangeable terms. That is, the remote monitoring system can be said to be a video processing system that processes a video and an image processing system that processes an image.

As illustrated in FIG. 4, the remote monitoring system 1 includes a plurality of terminals 100, a center server 200, a base station 300, and a MEC 400. The terminal 100, the base station 300, and the MEC 400 are disposed on a site side, and the center server 200 is disposed on a center side. For example, the center server 200 is disposed in a data center or a monitoring center disposed at a position away from the site. The site side is also an edge side of the system, and the center side is also a cloud side. In the present specification, a site where the terminal is installed or a place close to the site may be referred to as a site side. In addition, an apparatus close to a terminal in a network hierarchy may also be described as an apparatus on the site side. Since the center server 200 is disposed at a place away from the apparatus on the edge side, it may be described as the center side as compared with the edge side. For example, the center server 200 may be disposed in a monitoring center or a data center installed at a place several kilometers away from an area where the site is located. In addition, since the center server 200 may be deployed on a cloud using a network virtualization technology or the like, the center side may be referred to as a cloud side. The center server 200 may include one apparatus or a plurality of apparatuses. A part or all of the center server 200 may be deployed in a cloud.

The terminal 100 and the base station 300 are communicatively connected by a network NW1. The network NW1 is, for example, a wireless network such as 4G, local 5G/5G, long term evolution (LTE), or wireless LAN. The base station 300 and the center server 200 are communicatively connected by a network NW2. The network NW2 includes, for example, a core network such as a 5th Generation Core network (5GC) or an Evolved Packet Core (EPC), the Internet, and the like. It can also be said that the terminal 100 and the center server 200 are communicably connected via the base station 300. The base station 300 and the MEC 400 are communicably connected by any communication method, but the base station 300 and the MEC 400 may be one apparatus.

The terminal 100 is a terminal apparatus connected to the network NW1, and is also a video generation apparatus that generates a video of the site. The terminal 100 acquires a video captured by a camera 101 installed at the site, and transmits the acquired video to the center server 200 via the base station 300. Note that the camera 101 may be disposed outside the terminal 100 or inside the terminal 100.

The terminal 100 compresses the video of the camera 101 to a predetermined bit rate, and transmits the compressed video. The terminal 100 has a compression efficiency optimization function 102 for optimizing compression efficiency and a video transmission function 103. The compression efficiency optimization function 102 includes performs region of interest (ROI; also referred to as a gaze region) control that controls the image quality of an ROI. The compression efficiency optimization function 102 reduces the bit rate by reducing the image quality of a region around the ROI including the person or the object while maintaining the image quality of the ROI. The video transmission function 103 transmits the video whose image quality is controlled to the center server 200.

The base station 300 is a base station apparatus of the network NW1, and is also a relay apparatus that relays communication between the terminal 100 and the center server 200. For example, the base station 300 is a local 5G base station, a 5G gNB (next generation node B), an LTE eNB (evolved node B), an access point of a wireless LAN, or the like, but may be another relay apparatus.

The multi-access edge computing (MEC) 400 is an edge processing apparatus disposed on an edge side of a system. The MEC 400 is an edge server that controls the terminal 100, and has a compression bit rate control function 401 that controls a bit rate of the terminal and a terminal control function 402. The compression bit rate control function 401 controls a bit rate of the terminal 100 by adaptive video distribution control or quality of experience (QoE) control. For example, the compression bit rate control function 401 predicts a recognition accuracy to be obtained while suppressing the bit rate according to the communication environment of the networks NW1 and NW2, and assigns the bit rate to the camera 101 of each terminal 100 so as to improve the recognition accuracy. The terminal control function 402 controls the terminal 100 to transmit the video of the assigned bit rate. The terminal 100 encodes the video to the assigned bit rate, and transmits the encoded video.

The center server 200 is a server installed on the center side of the system. The center server 200 may be one or more physical servers, a cloud server built on a cloud, or other virtualization servers. The center server 200 is a monitoring apparatus that monitors work at a site by recognizing work of a person from a camera video of the site. The center server 200 is also a recognition apparatus that recognizes an action or the like of a person in the video transmitted from the terminal 100.

The center server 200 includes a detection unit 11, a trajectory prediction unit 12, a tracking unit 13, and a trajectory information output unit 14. The detection unit 11 detects an object or a person by inputting the video transmitted from terminal 100 to a video recognition artificial intelligence (AI) engine. The trajectory prediction unit 12 predicts a trajectory of the detected object or person. The tracking unit 13 tracks the object and estimates the trajectory of the object or the person in the missing region. The trajectory information output unit 14 displays a video of the terminal 100 and a tracking result on a graphical user interface (GUI).

In particular, in the remote monitoring system, when the communication quality between the site and the center deteriorates, the image quality of the video received on the center side deteriorates. For this reason, there is a problem that the monitoring target cannot be accurately recognized and tracked from the video received by the center side.

### (Description of Video Processing System According to First Example Embodiment)

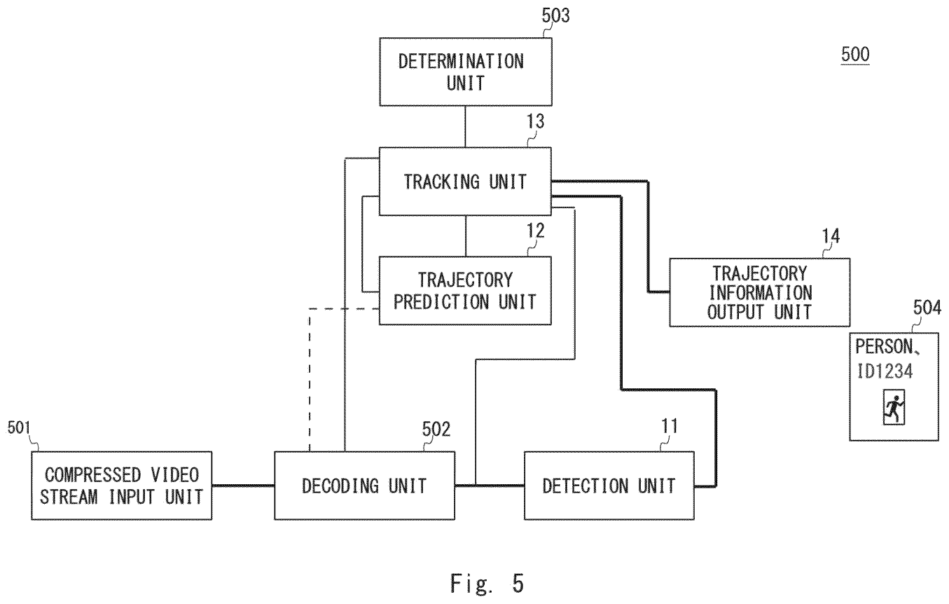

Hereinafter, a video processing system according to a first example embodiment will be described with reference to the drawings. The video processing system 500 is mainly constructed by the center server 200 described with reference to FIG. 4. FIG. 5 is a block diagram of the video processing system according to the first example embodiment. Note that the configuration of each apparatus is an example, and other configurations may be used as long as the operation according to the example embodiment described below can be performed. For example, some functions of the terminal 100 may be deployed in the center server 200 or another apparatus, or some functions of the center server 200 may be deployed in the terminal 100 or another apparatus.

As illustrated in FIG. 5, the video processing system 500 according to the first example embodiment includes a compressed video stream input unit 501, a decoding unit 502, a detection unit 11, a trajectory prediction unit 12, a tracking unit 13, a determination unit 503, and a trajectory information output unit 14. The video processing system 500 is obtained by adding a compressed video stream input unit 501, a decoding unit 502, a determination unit 503, and a trajectory information output unit 14 to the video processing system 10.

The compressed video stream input unit 501 is a portion having a function of stream inputting the video compressed by the terminal 100. The compressed video is sent to the decoding unit 502.

The decoding unit 502 decodes the compressed video. The decoded video is sent as video frame information to the detection unit 11. Further, the video frame information is sent to the tracking unit 13. At the same time, the decoded video is determined as to whether the missing region is present or absent. The decoding unit 502 provides information on the presence or absence of the missing region, and in some cases, information on the position of the missing region, to the tracking unit 13. In some cases, the decoding unit 502 may transmit motion vector information of the tracking target to the trajectory prediction unit 12.

The detection unit 11 detects an object and a person that are the tracking target from the input video. For example, in a case where a person is detected, the detection unit 11 assigns 1234 to the person as an identification number and sends the identification number to the tracking unit 13. In addition, the detection unit 11 calculates a detection reliability. The detection reliability is a numerical value indicating a certainty of detection, and is represented by a numerical value from 0 to 1, a rate, or an index.

The trajectory prediction unit 12 predicts a trajectory of the tracking target in the video. The trajectory prediction unit 12 sends a rectangular position predicted based on the predicted trajectory of the tracking target to the tracking unit 13. The trajectory prediction unit 12 predicts the trajectory of the tracking target in each frame. The trajectory prediction unit 12 calculates a prediction reliability. The prediction reliability is a numerical value indicating a certainty of prediction, and is represented by a numerical value from 0 to 1, a rate, or an index.

The trajectory prediction unit 12 can predict the trajectory of the tracking target by learning the type and operation of the tracking target by AI. The trajectory prediction unit 12 learns the past type and operation of the tracking target, and when a missing region appears, specifies the type of the tracking target appearing in the frame before the missing region appears. The type of the tracking target is classified into a type of an object having a characteristic motion such as a person, a bicycle, or an automobile. The type of the tracking target is specified by the detection unit 11, and the result is received by the trajectory prediction unit 12. For example, the trajectory prediction unit learns that, in a case where the tracking target is a person, the tracking target is relatively slow and moves from the current position to the periphery, and learns that, in a case where the tracking target is an automobile, the tracking target moves relatively quickly along a lane. Then, the trajectory prediction unit 12 can predict the operation of the tracking target in the missing region from the learning result and the specified type of the tracking target.

Further, the trajectory prediction unit 12 can predict the trajectory of the tracking target using the motion vector assigned by the decoding unit. The trajectory prediction unit 12 acquires the tracking target to which the motion vector is assigned, and when the missing region appears, specifies the position of the tracking target captured in the frame before the missing region appears. The trajectory prediction unit 12 can predict the position of the tracking target in the missing region from the specified position and motion vector of the tracking target.

The tracking unit 13 sends the tracking result corresponding to the frame to the trajectory prediction unit 12, and feeds back the prediction of the trajectory prediction unit 12. In a case where there is no missing region, the tracking unit 13 sends the detection result and the tracking result to the determination unit 503. The determination unit 503 determines whether or not the tracking target tracked by the tracking unit is the same as the tracking target detected by the detection unit. Then, the determination unit 503 returns the determination result to the tracking unit 13. If they are the same, the tracking unit 13 assigns the same identification number (ID) (identification) to the tracking target and sends the tracking result to the trajectory information output unit 14. If they are not same, the tracking unit 13 assigns a new identification number to the tracking target and sends the tracking result to the trajectory information output unit 14. A name or a reference sign may be assigned instead of the identification number. These identification numbers, reference signs, and names are used as identification information.

When there is the missing region and the tracking target is included in the missing region, the tracking unit 13 estimates the position of the tracking target in the missing region using the prediction result of the trajectory prediction unit 12. While there is the missing region, the tracking result is not sent to the determination unit 503. Then, when the missing region disappears or when the tracking target appears from the missing region, the tracking unit 13 sends the detection result and the tracking result to the determination unit 503. The determination unit 503 determines whether or not the tracking target tracked by the tracking unit is the same as the tracking target detected by the detection unit 11. The determination unit 503 returns the determination result to the tracking unit 13. If they are the same, the tracking unit 13 assigns the same identification number to the tracking target and sends the tracking result to the trajectory information output unit 14. If they are not same, the tracking unit 13 assigns a new identification number to the tracking target and sends the tracking result to the trajectory information output unit 14.

When there is no missing region, the trajectory information output unit 14 displays the detected tracking target with a rectangle and identification information attached thereto. For example, as illustrated in a rectangle 504 of FIG. 5, the trajectory information output unit 14 assigns 1234 as an identification number to a rectangle surrounding a person and displays the rectangle. When there is the missing region, the trajectory information output unit 14 displays a video in which the rectangle and the identification information are superimposed on the estimated position of the tracking target.

As the rectangle 504 displayed in the missing region, a picture or a symbol imitating the tracking target or a cut-out of the video detected in the previous frame can also be arranged. In addition, the rectangle 504 may be superimposed on the video with increased transmittance, or a color of a frame line may be changed. For example, it is possible to add red color to a visible object and add blue color to a predicted object. Furthermore, the rectangle 504 can take various forms such as a dotted line, a solid line, or a one-dot chain line as the frame line.

In addition, the trajectory information output unit 14 calculates trajectory reliability based on the prediction reliability and the detection reliability. The trajectory reliability is a numerical value indicating a certainty of trajectory, and is represented by a numerical value from 0 to 1, a rate, or an index. The trajectory reliability is calculated based on the detection reliability and the prediction reliability. Since the trajectory reliability is determined to be constant based on the presence of the tracking target in the missing region, the trajectory reliability does not fall below a predetermined value. Therefore, the tracking target is stored while being in the missing region. In this way, it is possible to reduce the possibility of ending the tracking of the tracking target while the tracking target is in the missing region.

The tracking unit 13 tracks the tracking target in each frame. When the above trajectory reliability falls below the predetermined value, the tracking unit 13 stops the tracking of the tracking target. Note that video processing system 500 described above may be configured by one apparatus or may be configured by a plurality of apparatuses. For example, the video processing system 500 may be implemented by communication between the compressed video stream input unit 501, the decoding unit 502, and the detection unit 11 as one apparatus, and the trajectory prediction unit 12, the tracking unit 13, the determination unit 503, and the trajectory information output unit 14 as one apparatus.

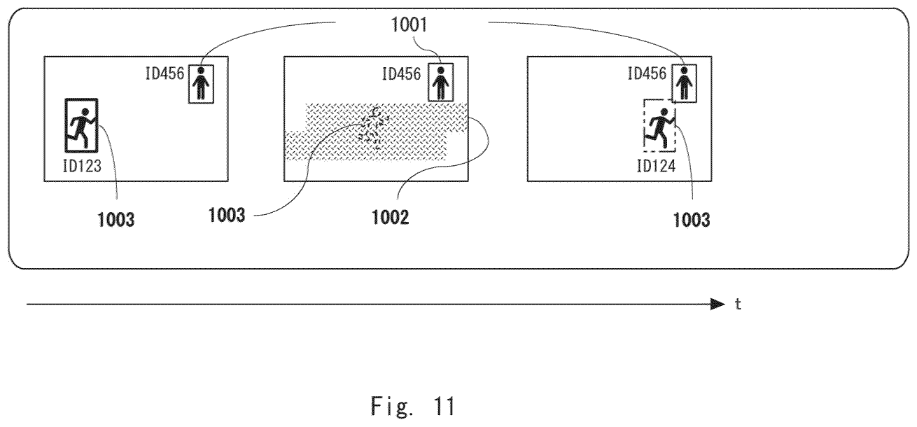

FIG. 11 is a diagram illustrating an example in which an object cannot be tracked due to a missing frame. FIG. 11 illustrates that time has elapsed in the order of the left diagram, the center diagram, and the right diagram. As shown in FIG. 11, when there is no tracking target in the missing region of the frame, an object 1001 can be tracked correctly, and the same object is tracked with the same identification number (here, an ID456). On the other hand, as illustrated in the center diagram of FIG. 11, when the missing occurs in the frame, an object 1003 to which an ID123 is assigned cannot be detected because the object 1003 is in the missing region 1002. Therefore, as illustrated in the right diagram of FIG. 11, after recovery of the missing frame, the object 1003 that cannot be detected due to the missing frame cannot be correctly tracked. As described above, there is a problem that an ID124, which is a new identification number, is assigned to the same object due to the missing frame.

In view of the above problem, in the video processing system according to the example embodiment, when there is a missing region in the video, the tracking target is tracked in the missing region using the prediction result of a tracking prediction unit. As a result, even in a case where an object cannot be detected due to a missing frame of a video, the object can be tracked. Therefore, it is possible to provide a suitable object tracking method at the time of video distribution via a network.

### (Description of Video Processing Method According to First Example Embodiment)

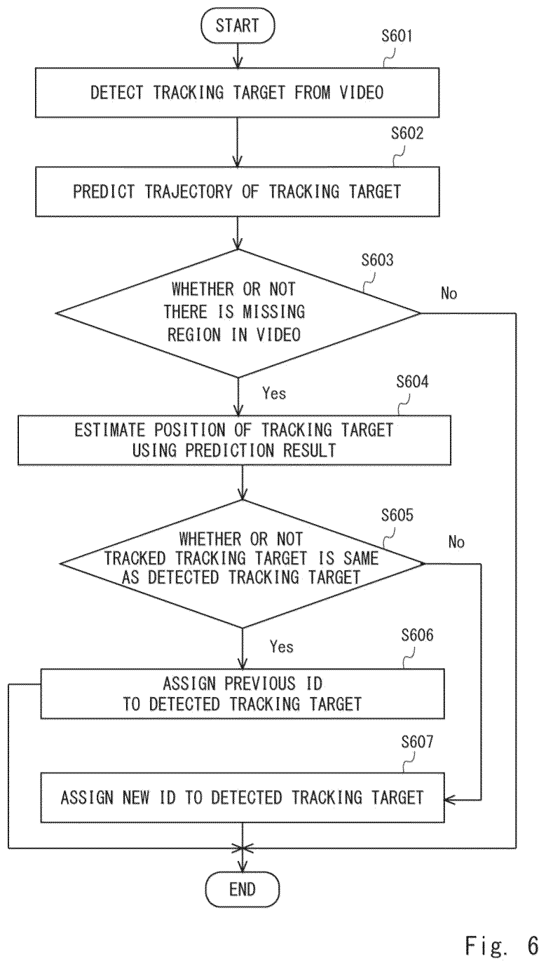

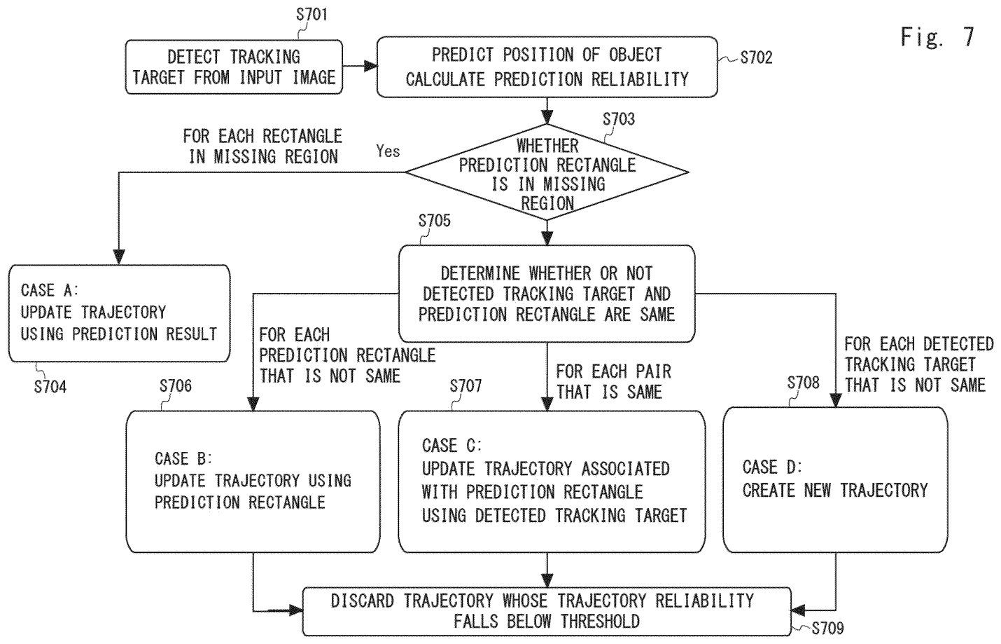

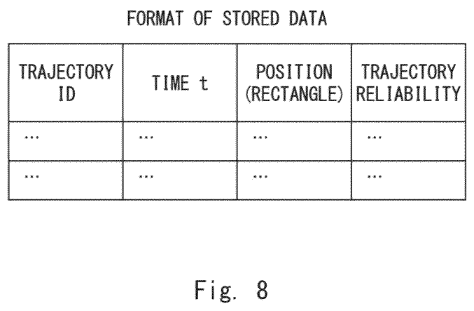

FIG. 6 is a flowchart of a video processing method according to the first example embodiment. FIG. 7 is a flowchart of a video processing method according to the first example embodiment. FIG. 8 is a diagram illustrating an example of a storage format of trajectory reliability according to the first example embodiment. The video processing method according to the first example embodiment will be described with reference to FIGS. 6 to 8.

As illustrated in FIG. 6, first, the tracking target is detected from the video (step S601). For example, the video is a video obtained by decoding a compressed video. The tracking target is detected from the input video. In the step of detecting the tracking target, the detection reliability indicating the reliability of the detection of the tracking target is calculated. Next, a trajectory of the tracking target is predicted (step S602). A trajectory of the tracking target in the input video described above is predicted. In the step of predicting the trajectory, the prediction reliability indicating the reliability of the prediction of the tracking target is calculated. Next, it is determined whether or not there is a missing region in the video (step S603).

When there is no missing region in the video (No in step S603), tracking of the tracking target is performed until the tracking target moves out of the imaging range, and the process ends. When there is a missing region in the video (Yes in step S603), the position of the tracking target is estimated using the prediction result (step S604). When there is a missing region in the video, the tracking target is tracked in the missing region using the prediction result of the step of predicting the trajectory.

Next, it is determined whether or not the tracked tracking target is the same as the detected tracking target (step S605). When the tracking target appears from the missing region, it is determined whether or not the tracking target tracked by the step of tracking of the tracking target is the same as the tracking target detected by the step of detecting the tracking target. If they are the same (Yes in step S605), the previous ID is assigned to the detected tracking target (step S606). If they are not same (No in step S605), a new ID is assigned to the detected target (step S607). Both in a case where they are the same and in a case where they are not same, a rectangle is superimposed on the video, an identification number is assigned to the rectangle, and the process ends. In the step of assigning the identification number, the trajectory reliability indicating the reliability of the trajectory of the tracking target is calculated based on the detection reliability and the prediction reliability. Since the trajectory reliability is determined to be constant and not to decrease based on the presence of the tracking target in the missing region, the trajectory reliability does not fall below a predetermined value. Therefore, the tracking target is stored while being in the missing region. In this way, it is possible to reduce the possibility of ending the tracking of the tracking target while the tracking target is in the missing region.

The step of tracking of the tracking target always tracks the tracking target. When the above trajectory reliability falls below a predetermined value, the tracking of the tracking target is stopped.

As described above, in the video processing method according to the first example embodiment, when there is a missing region in the video, the position of the tracking target in the missing region is estimated using the prediction result of a tracking prediction unit. As a result, even in a case where an object cannot be detected due to a missing frame of a video, the object can be tracked.

In FIG. 7, the detection reliability, the prediction reliability, and the trajectory reliability will be described in more detail. First, the tracking target is detected from the input image (step S701). Next, the position of the object is predicted. Further, the prediction reliability is calculated (step S702). A position (rectangle) in the next frame is predicted for the trajectory of the tracking target whose trajectory is predicted after being already detected. The tracking target whose trajectory is predicted after being detected means not the tracking target detected in the frame but the tracking target detected in the previous frame and whose trajectory is predicted and stored. The prediction reliability is a number obtained by multiplying the trajectory reliability of the stored tracking target by a specific coefficient of prediction. Next, it is determined whether or not a prediction rectangle is an object in the missing region (step S703).

Case A is a case where the prediction rectangle is in the missing region (Yes in step S703). Case A updates the trajectory using the prediction result (step S704). That is, for each rectangle in the missing region, the trajectory associated with the prediction is updated using the prediction result (rectangle, reliability). In this case, since the rectangle is not shown in the video, it is not determined whether or not the detected tracking target and the prediction rectangle are the same. The prediction reliability is defined as a trajectory reliability. In addition, since the prediction reliability is determined to be constant based on the presence of the tracking target in the missing region, the prediction reliability does not fall below a predetermined value. Therefore, the trajectory reliability also does not fall below the predetermined value.

If the prediction rectangle is outside the missing region (No in step S703), it is determined whether or not the detected tracking target and the prediction rectangle are the same (step S705). That is, it is determined whether or not the tracked or predicted tracking target is the same as the detected tracking target. For example, intersection over union (IoU) (overlapping degree) of each detected tracking target and the prediction rectangle and the like are weighted and solved by the Hungarian algorithm. In addition, a unique feature amount may be compared to a person, a bicycle, or an automobile to determine whether or not they are the same or not.

A process performed for each of the prediction rectangle that is not same as the detected tracking target is referred to as Case B. Case B updates the trajectory using the prediction rectangle (step S706). That is, the prediction rectangle is used to update (continue) the trajectory associated with the prediction. The number obtained by multiplying the prediction reliability by a constant coefficient of 1.0 or less is defined as the updated trajectory reliability.

A process performed for each of the detected tracking target and the prediction rectangle that are the same is referred to as Case C. Case C updates (continues) the trajectory associated with the prediction rectangle using the detected tracking target (step S707). That is, the trajectory associated with the prediction rectangle is updated using the detected tracking target. The updated trajectory reliability is calculated based on the prediction reliability and the detection reliability.

A process performed for each detected tracking target that is not the same as the prediction rectangle is referred to as Case D. Case D creates a new trajectory (step S708). That is, a new identification number is assigned to the detected tracking target and stored. The trajectory reliability is stored following the detection reliability.

Then, in Cases B, C, and D, the trajectory whose trajectory reliability falls below the threshold is discarded (step S709). That is, the trajectory of the tracking target is deleted. In other words, the tracking is stopped for the tracking target. Such a response prevents the number of tracking targets from increasing and diverging.

FIG. 8 illustrates a table of the trajectory ID, the time t, the position (rectangle), and the trajectory reliability. The table is stored in a storage unit of the center server or a cloud of the system. The time t is a current time, and the position is a coordinate in the video. With such a table, the trajectory reliability is stored.

### (Description of Example of Detection of Tracking Target According to Example Embodiment)

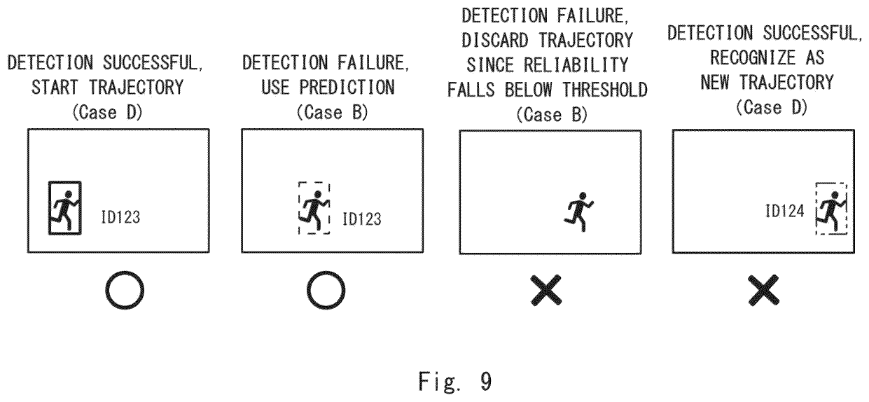

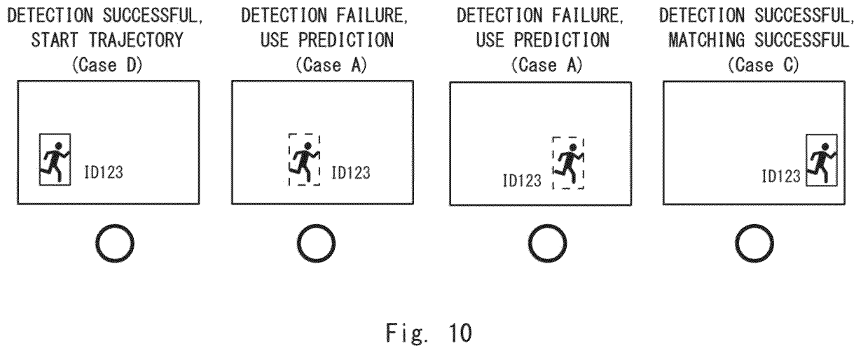

FIG. 9 is a diagram illustrating a detection example in which the trajectory reliability decreases according to the first example embodiment. FIG. 10 is a diagram illustrating a detection example in which the trajectory reliability is constant and does not fall below a predetermined value according to the first example embodiment. An example of detection of a tracking target according to the first example embodiment will be described with reference to FIGS. 9 and 10. ∘ in FIGS. 9 and 10 indicates a state in which the tracking has succeeded, and x in FIGS. 9 and 10 indicates a state in which the tracking has failed.

The left diagram in FIG. 9 illustrates Case D which is a scene of the tracking target being detected. Tracking of the trajectory is started from here. An ID123 which is an identification number is assigned to the tracking target. The middle left diagram of FIG. 9 illustrates a scene where the detection of the tracking target has failed because the missing region exists in the frame. In this case, Case B in which the operation of specifying the trajectory of the tracking target is performed using the prediction result is illustrated. The middle right diagram of FIG. 9 illustrates a scene where the trajectory reliability falls below the threshold, in other words, a scene where the trajectory is discarded, that is, the tracking is stopped in Case B. The right diagram in FIG. 9 illustrates Case D which is a scene of the tracking target being detected. In this case, it is recognized that the detection target and the tracking target are not the same and the detection target is a new tracking target, and an ID124 is assigned as an identification number. In the related method, that is, the detection method that depends only on the trajectory reliability, when the detection fails, the prediction reliability, that is, the trajectory reliability decreases, so that the trajectory is discarded and a new identification number is assigned.

The left diagram in FIG. 10 illustrates Case D in which the tracking target is detected. Tracking of the trajectory is started from here. An ID123 which is an identification number is assigned to the tracking target. The middle left diagram of FIG. 10 illustrates a scene where the detection of the tracking target has failed because the missing region exists in the frame. In this case, Case A in which trajectory tracking is performed using prediction is illustrated. The middle right diagram of FIG. 10 illustrates a scene where the trajectory reliability is made constant and does not fall below the threshold. This is the case of Case A in which trajectory tracking is performed using prediction. The right diagram in FIG. 10 illustrates Case C which is a scene of the tracking target being detected and the detected tracking target and the tracked tracking target being determined to be the same in determination. In this case, an ID123 which is the previous identification number is assigned to the detected tracking target. As described above, in the method of the present disclosure, the prediction reliability, that is, the trajectory reliability is constant and does not fall below the threshold, and thus the identification number is not updated.

In this way, the prediction reliability, that is, the trajectory reliability does not fall below the predetermined value, and the trajectory is stored, whereby the update of the identification number can be prevented.

Each configuration in the above-described example embodiments may be implemented by hardware, software, or both, and may be implemented by one piece of hardware or software or by a plurality of pieces of hardware or software. The functions of each apparatus may be implemented by a computer having a central processing unit (CPU), a memory, and the like. For example, a program for performing the method in the example embodiment may be stored in a storage device, and each function may be realized by executing the program stored in the storage device by the CPU.

These programs include a group of instructions (or software codes) causing a computer to perform one or more of the functions described in the example embodiments when read by the computer. The program may be stored in a non-transitory computer-readable medium or a tangible storage medium. As an example and not by way of limitation, the computer-readable medium or the tangible storage medium includes a random-access memory (RAM), a read-only memory (ROM), a flash memory, a solid-state drive (SSD) or any other memory technology, a CD-ROM, a digital versatile disc (DVD), a Blu-ray (registered trademark) disc or any other optical disc storage, a magnetic cassette, a magnetic tape, and a magnetic disk storage or any other magnetic storage device. The program may be transmitted on a transitory computer-readable medium or a communication medium. By way of example, and not limitation, transitory computer-readable or communication media include electrical, optical, acoustic, or other forms of propagated signals.

Note that the present disclosure is not limited to the above-described example embodiments, and can be appropriately modified without departing from the scope.

Some or all of the above example embodiment may be described as the following supplementary notes but are not limited to the following.

### Supplementary Note 1

A video processing system including:
a detection means for detecting a tracking target from an input video;
a trajectory prediction means for predicting a trajectory of the tracking target in the video; and
a tracking means for tracking the tracking target, and when there is a missing region in the video, for estimating a position of the tracking target in the missing region using a prediction result of the trajectory prediction means.

### Supplementary Note 2

The video processing system according to supplementary note 1, further including:
a determination means for determining whether or not the tracking target tracked by the tracking means is the same as the tracking target detected by the detection means; and
a trajectory information output means for assigning identification information to the detected tracking target.

### Supplementary Note 3

The video processing system according to supplementary note 2, in which
the trajectory prediction means calculates a prediction reliability indicating a reliability of prediction of the tracking target, and
the tracking means stops the tracking of the tracking target according to the prediction reliability.

### Supplementary Note 4

The video processing system according to supplementary note 3, in which
the detection means calculates a detection reliability indicating a reliability of detection of the tracking target,
the trajectory information output means calculates a trajectory reliability indicating a reliability of the trajectory of the tracking target based on the detection reliability and the prediction reliability, and
the tracking means stops the tracking of the tracking target according to the trajectory reliability.

### Supplementary Note 5

The video processing system according to supplementary note 4, in which the trajectory reliability is not decreased while the tracking target is in the missing region.

### Supplementary Note 6

The video processing system according to supplementary note 2, in which the trajectory information output means superimposes the detected tracking target on the video.

### Supplementary Note 7

The video processing system according to any one of supplementary notes 1 to 6, further including a decoding means for decoding the input video,
in which the decoding means provides the information of the missing region to the tracking means.

### Supplementary Note 8

The video processing system according to any one of supplementary notes 1 to 7, in which
the trajectory prediction means learns an operation according to a type of the tracking target in the past,
when the missing region appears, specifies the type of the tracking target appearing in a frame before the missing region appears, and
predicts the operation of the tracking target in the missing region from a result of the learning and the specified type of the tracking target.

### Supplementary Note 9

The video processing system according to any one of supplementary notes 1 to 7, in which
the trajectory prediction means acquires the tracking target to which a motion vector is assigned,
when the missing region appears, specifies a position of the tracking target appearing in a frame before the missing region appears, and
predicts the position of the tracking target in the missing region from the specified position of the tracking target and the motion vector.

### Supplementary Note 10

A video processing method including:
detecting a tracking target from an input video;
predicting a trajectory of the tracking target in the video; and
when the tracking target is tracked, in a case where there is a missing region in the video, estimating a position of the tracking target in the missing region using a result of prediction of the trajectory.

### Supplementary Note 11

The video processing method according to supplementary note 10, further including:
determining whether or not the tracking target tracked by the tracking of the tracking target is the same as the tracking target detected by the detecting of the tracking target; and
assigning identification information to the detected tracking target.

### Supplementary Note 12

The video processing method according to supplementary note 11, in which
in the predicting of the trajectory, a prediction reliability indicating a reliability of the predicting of the tracking target is calculated, and
the tracking of the tracking target is stopped according to the prediction reliability.

### Supplementary Note 13

The video processing method according to supplementary note 12, in which
in the detecting of the tracking target, a detection reliability indicating a reliability of the detecting of the tracking target is calculated,
in the assigning of the identification information, a trajectory reliability indicating a reliability of the trajectory of the tracking target is calculated based on the detection reliability and the prediction reliability, and
the tracking of the tracking target is stopped according to the trajectory reliability.

### Supplementary Note 14

The video processing method according to supplementary note 13, in which the trajectory reliability is not decreased while the tracking target is in the missing region.

### Supplementary Note 15

The video processing method according to supplementary note 11, in which in the assigning of the identification information, the detected tracking target is superimposed on the video.

### Supplementary Note 16

The video processing method according to any one of supplementary notes 10 to 15, further including decoding the input video,
in which the decoding of the video provides the information of the missing region to the tracking of the tracking target.

### Supplementary Note 17

The video processing method according to any one of supplementary notes 10 to 16, in which
in the predicting of the trajectory, an operation based on a type of the tracking target in the past is learned,
when the missing region appears, the type of the tracking target appearing in a frame before the missing region appears is specified, and
the operation of the tracking target in the missing region is predicted from a result of the learning and the specified type of the tracking target.

### Supplementary Note 18

The video processing method according to any one of supplementary notes 10 to 16, in which
in the predicting of the trajectory, the tracking target to which a motion vector is assigned is acquired,
when the missing region appears, a position of the tracking target appearing in a frame before the missing region appears is specified, and
the position of the tracking target in the missing region is predicted from the specified position of the tracking target and the motion vector.

### Supplementary Note 19

A video processing apparatus including:
a detection means for detecting a tracking target from an input video;
a trajectory prediction means for predicting a trajectory of the tracking target in the video; and
a tracking means for tracking the tracking target, and when there is a missing region in the video, for estimating a position of the tracking target in the missing region using a prediction result of the trajectory prediction means.

### Supplementary Note 20

The video processing apparatus according to supplementary note 19, further including:
a determination means for determining whether or not the tracking target tracked by the tracking means is the same as the tracking target detected by the detection means; and
a trajectory information output means for assigning identification information to the detected tracking target.

### Supplementary Note 21

The video processing apparatus according to supplementary note 20, in which
the trajectory prediction means calculates a prediction reliability indicating a reliability of prediction of the tracking target, and
the tracking means stops the tracking of the tracking target according to the prediction reliability.

### Supplementary Note 22

The video processing apparatus according to supplementary note 21, in which
the detection means calculates a detection reliability indicating a reliability of detection of the tracking target,
the trajectory information output means calculates a trajectory reliability indicating a reliability of the trajectory of the tracking target based on the detection reliability and the prediction reliability, and
the tracking means stops the tracking of the tracking target according to the trajectory reliability.

### Supplementary Note 23

The video processing apparatus according to supplementary note 22, in which the trajectory reliability is not decreased while the tracking target is in the missing region.

### Supplementary Note 24

The video processing apparatus according to supplementary note 20, in which the trajectory information output means superimposes the detected tracking target on the video.

### Supplementary Note 25

The video processing apparatus according to any one of supplementary notes 19 to 24, further including a decoding means for decoding the input video,
in which the decoding means provide the information of the missing region to the tracking means.

### Supplementary Note 26

The video processing apparatus according to any one of supplementary notes 19 to 25, in which
the trajectory prediction means learns an operation according to a type of the tracking target in the past,
when the missing region appears, specifies the type of the tracking target appearing in a frame before the missing region appears, and
predicts the operation of the tracking target in the missing region from a result of the learning and the specified type of the tracking target.

### Supplementary Note 27

The video processing apparatus according to any one of supplementary notes 19 to 25, in which
the trajectory prediction means acquires the tracking target to which a motion vector is assigned,
when the missing region appears, specifies a position of the tracking target appearing in a frame before the missing region appears, and
predicts the position of the tracking target in the missing region from the specified position of the tracking target and the motion vector.

### REFERENCE SIGNS LIST

1 REMOTE MONITORING SYSTEM
10 VIDEO PROCESSING SYSTEM
11 DETECTION UNIT
12 TRAJECTORY PREDICTION UNIT
13 TRACKING UNIT
14 TRAJECTORY INFORMATION OUTPUT UNIT
20 VIDEO PROCESSING APPARATUS
100 TERMINAL
100 CAMERA
102 COMPRESSION EFFICIENCY OPTIMIZATION FUNCTION
200 CENTER SERVER
300 BASE STATION
400 MEC
401 COMPRESSION BIT RATE CONTROL FUNCTION
500 VIDEO PROCESSING SYSTEM
50 COMPRESSED VIDEO STREAM INPUT UNIT
502 DECODING UNIT
503 DETERMINATION UNIT
504 RECTANGLE
1001 OBJECT
1002 MISSING REGION
1003 OBJECT
1004 OBJECT

What is claimed is:

1. A video processing system comprising:
at least one memory storing instructions, and
at least one processor configured to execute the instructions to:
detect a tracking target from an input video;
predict a trajectory of the tracking target in the video; and
track the tracking target, and when there is a missing region in the video, estimate a position of the tracking target in the missing region using a prediction result of the trajectory.

2. The video processing system according to claim 1, wherein the at least one processor is configured to execute the instructions to:
determine whether the tracking target tracked by the tracking of the tracking target is the same as a detected tracking target; and
assign identification information to the detected tracking target.

3. The video processing system according to claim 2, wherein the at least one processor is configured to execute the instructions to:
calculate a prediction reliability indicating a reliability of prediction of the tracking target, and
stop the tracking of the tracking target according to the prediction reliability.

4. The video processing system according to claim 3, wherein the at least one processor is configured to execute the instructions to:
calculate a detection reliability indicating a reliability of detection of the tracking target,
calculate a trajectory reliability indicating a reliability of the trajectory of the tracking target based on the detection reliability and the prediction reliability, and
stop the tracking of the tracking target according to the trajectory reliability.

5. The video processing system according to claim 4, wherein the trajectory reliability is not decreased while the tracking target is in the missing region.

6. The video processing system according to claim 1, wherein the at least one processor is configured to execute the instructions to:
learn an operation according to a type of the tracking target,
when the missing region appears, specify the type of the tracking target appearing in a frame before the missing region appears, and
predict the operation of the tracking target in the missing region from a result of the learning and the specified type of the tracking target.

7. The video processing system according to claim 1, wherein the at least one processor is configured to execute the instructions to:
acquire the tracking target to which a motion vector is assigned,
when the missing region appears, specify a position of the tracking target appearing in a frame before the missing region appears, and
predict the position of the tracking target in the missing region from the specified position of the tracking target and the motion vector.

8. A video processing method comprising:
detecting a tracking target from an input video;
predicting a trajectory of the tracking target in the video; and
when the tracking target is tracked, in a case where there is a missing region in the video, estimating a position of the tracking target in the missing region using a result of prediction of the trajectory.

9. The video processing method according to claim 8, further comprising:
determining whether or not the tracking target tracked by the tracking of the tracking target is the same as a detected tracking target; and
assigning identification information to the detected tracking target.

10. The video processing method according to claim 9, wherein
in the predicting of the trajectory, a prediction reliability indicating a reliability of the predicting of the tracking target is calculated, and
the tracking of the tracking target is stopped according to the prediction reliability.

11. The video processing method according to claim 10, wherein
in the detecting of the tracking target, a detection reliability indicating a reliability of the detecting of the tracking target is calculated,
in the assigning of the identification information, a trajectory reliability indicating a reliability of the trajectory of the tracking target is calculated based on the detection reliability and the prediction reliability, and
the tracking of the tracking target is stopped according to the trajectory reliability.

12. The video processing method according to claim 11, wherein the trajectory reliability is not decreased while the tracking target is in the missing region.

13. The video processing method according to claim 8, wherein
in the predicting of the trajectory, an operation based on a type of the tracking target in the past is learned,
when the missing region appears, the type of the tracking target appearing in a frame before the missing region appears is specified, and
the operation of the tracking target in the missing region is predicted from a result of the learning and the specified type of the tracking target.

14. The video processing method according to claim 8, wherein
in the predicting of the trajectory, the tracking target to which a motion vector is assigned is acquired,
when the missing region appears, a position of the tracking target appearing in a frame before the missing region appears is specified, and
the position of the tracking target in the missing region is predicted from the specified position of the tracking target and the motion vector.

15. A video processing apparatus comprising:
at least one memory storing instructions, and
at least one processor configured to execute the instructions to:
detect a tracking target from an input video;
predict a trajectory of the tracking target in the video; and
track the tracking target, and when there is a missing region in the video, estimate a position of the tracking target in the missing region using a prediction result of prediction of the trajectory.

16. The video processing apparatus according to claim 15, wherein the at least one processor is configured to execute the instructions to:
determine whether or not the tracking target tracked by the tracking of the tracking target is the same as a detected tracking target; and
assign identification information to the detected tracking target.

17. The video processing apparatus according to claim 16, wherein the at least one processor is configured to execute the instructions to:
calculate a prediction reliability indicating a reliability of prediction of the tracking target, and
stop the tracking of the tracking target according to the prediction reliability.

18. The video processing apparatus according to claim 17, wherein the at least one processor is configured to execute the instructions to:
calculate a detection reliability indicating a reliability of detection of the tracking target,
calculate a trajectory reliability indicating a reliability of the trajectory of the tracking target based on the detection reliability and the prediction reliability, and
stop the tracking of the tracking target according to the trajectory reliability.

19. The video processing apparatus according to claim 18, wherein the trajectory reliability is not decreased while the tracking target is in the missing region.

20. The video processing apparatus according to claim 15, wherein the at least one processor is configured to execute the instructions to:
learn an operation according to a type of the tracking target in the past,
when the missing region appears, specify the type of the tracking target appearing in a frame before the missing region appears, and
predict the operation of the tracking target in the missing region from a result of the learning and the specified type of the tracking target.
